(19) United States
(12) Patent Application Publication
(10) Pub. No.: US 2005/0233930 A1
(43) Pub. Date: Oct. 20, 2005

(54) Disinfectant cleaning compositions

(75) Inventors: Tak Wai Cheung, Montvale, NJ (US); Delford Ian Christmas, Montvale, NJ (US); Ramakrishnan Hariharan, Montvale, NJ (US); Robert Lu, Montvale, NJ (US); Vu Dong Nguyen, Falls Church, VA (US)

Correspondence Address: NORRIS, MCLAUGHLIN & MARCUS, 875 THIRD AVE, 18TH FLOOR, NEW YORK, NY, 10022, US

(73) Assignee: Reckitt Benckiser Inc., Parsippany, NJ (US)

(21) Appl. No.: 10/530,433

(22) PCT Filed: Oct. 13, 2003
(86) PCT No.: PCT/GB03/04422

§ 371 Date: Jun. 13, 2005

(30) Foreign Application Priority Data
Oct. 12, 2002 (GB) 0223847.5

(51) Int. Cl. C11D 17/00

(52) U.S. Cl. 510/407

(57) ABSTRACT

The present invention provides a non-cationic antimicrobial agent containing composition which blooms when added to water. The compositions have good cleaning, disinfecting and bloom properties.

The present invention is directed to concentrated cleaning and/or disinfecting compositions which bloom when diluted in water.

Cleaning compositions are commercially important products and enjoy a wide field of utility in assisting in the removal of dirt and grime from surfaces, especially those characterized as useful with hard surfaces. One particular category of cleaning compositions are those which provide a blooming effect. Such an effect may be described as the change of the water's appearance from essentially colorless and transparent to that of a milky white or milky yellowish white, cloudy appearance upon the addition of an amount of the cleaning composition. This effect is also sometimes referred to as the “break”. Such blooming is a highly desirable in such pine oil type cleaning compositions as consumer/end user expectations associate cleaning effectiveness/disinfection with the extent and degree of this blooming upon formation of a cleaning composition. Such an effect is particularly known and generally associated with pine oil type cleaning compositions which typically include one or more of the following identifying characteristics: containing an amount of one or more resins or oils derived from coniferous species of trees; containing natural fragrances or synthetic fragrance compositions which are intended to mimic the scent of one or more resins or oils derived from coniferous species of trees; a color ranging from colorless to a deep amber, deep amber yellow or deep amber reddish color; generation of a milky or cloudy appearance when diluted with water in dilutions useful for cleaning applications. Such pine oil type cleaning compositions are generally provided in a concentrated composition which is subsequently diluted with water by an end user/consumer to form a cleaning composition therefrom.

Thus, the present invention provides a hard surface cleaning concentrate composition comprising:
a) from about 0.05 to about 15 wt %, preferably about 0.1 to about 5 wt %, and more preferably from about 0.5 to about 5 wt % of a non-cationic antimicrobial agent;
b) from about 0.1 to about 20 wt % and more preferably from about 0.5 to about 10 Wt % of a water soluble organic solvent;
c) from about 0.1 to about 30 wt %, preferably from about 1 to about 20 wt %, and more preferably from about 2 to about 15 wt % of an anionic soap surfactant;
d) from about 0.1 to about 15 wt %, preferably from about 0.1 to about 10 wt %, and more preferably from about 0.5 to about 5 wt % of an hydrocarbon diluent;
e) from about 0.001 to about 10 wt %, preferably from about 0.1 to about 5 wt %, and more preferably from about 0.5 to about 5 wt % of pine oil which is at least 60% terpene alcohols;
f) optionally, from about 0 to about 10 wt % of optional materials selected from dyes, colorants, pH stabilizers and buffers, non-ionic surfactants, fragrance/fragrance enhancers which do not interfere with the pine oil constituent, viscosity modifiers, insect repellants, and light stabilizers; and
g) the balance being water.

In some preferred embodiments, one or more insect repellants is present.

Preferably, the non-cationic antimicrobial agent is selected from pyrithiones, dimethyldimethylol hydantoin, methylchloroisothiazolinone/methylisothiazolinone sodium sulfite, sodium bisulfite, imidazolidinyl urea, diazolidinyl urea, benzyl alcohol, 2-bromo-2-nitropropane-1,3-diol, formalin (formaldehyde), iodopropenyl butylcarbamate, chloroacetamide, methanamine, methyldibromonitrile glutaronitrile, glutaraldehyde, 5-bromo-5-nitro-1,3-dioxane, phenethyl alcohol, o-phenylphenol/sodium o-phenylphenol, sodium hydroxymethylglycinate, polymethoxy bicyclic oxazolidine, dimethoxane, thilersal dichlorobenzyl alcohol, captan, chlorphenenesin, dichlorophene, chlorbutanol, glyceryl laurate, halogenated diphenyl ethers, phenolic compounds, mono- and poly-alkyl and aromatic halophenols, resorcinol and its derivatives, bisphenolic compounds, benzoic esters (parabens), halogenated carbanilides, 3-trifluoromethyl-4,4′-dichlorocarbanilide, and 3,3′,4 trichlorocarbanilide. More preferably, the non-cationic antimicrobial agent is a mono- and poly-alkyl and aromatic halophenol selected from the group p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol 2-diethylmethyl-3,5-dimethyl p-chlorophenol, 6-sec-octyl-3-methyl p-chlorophenol, p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, dichloro meta xylenol, chlorothymol, and 5-chloro-2-hydroxydiphenylmethane.

Preferably, the water soluble organic solvents are short chain alcohols.

Preferably, for the anionic soap surfactants, alkyl metal soaps and alkylaryl sulfonates are preferred with alkyl metal soaps, such as sodium or potassium castor oil soap, being preferred.

Preferably, the hydrocarbon diluent is an aromatic hydrocarbon diluent, preferably selected from Shellsolv AB, Aromatic 150, Aromatic 200 (naphthalene depleted), Aromatic 200, Aromatic 100, and HAN 857.

According to certain especially preferred embodiments, the concentrate compositions may be characterized in that when the concentrate compositions are diluted at a ratio of 1 part to 100 parts water at 20° C. or 40° C. the resultant mixture exhibits a light transmittance loss of at least 50%. In particularly preferred embodiments the concentrate compositions do not form a gel at usual storage conditions (room temperature, approx. 20° C.), and exhibit a satisfactory blooming effect when added to a larger volume of water where such water is either at room temperature or at a higher temperature, particularly at approx. 40° C. According to preferred embodiments, the concentrate compositions cause a drop in transmitted light through water of at least 20%, more desirably at least about 30% and more when used to form a cleaning composition therefrom, particularly at a dilution of 1 part cleaning concentrate to 100 parts water relative to the transmittance of water, which is established to be 100%. According to particularly preferred embodiments the concentrate compositions cause a drop in transmitted light through water of at least about 40% when added to water at 40° C., and also cause a drop in transmitted light through water of at least 40%, more desirably at least 50%, when added to water at 20° C. Most preferred are compositions which exhibit a drop in transmitted light of at least 70% when added to water at 20° C., and which exhibit a drop in transmitted light of at least 60% when added to water at 40° C. wherein the dilutions of concentrate composition to water is 1:100.

The antimicrobial agents of the present invention are non-cationic in order to avoid interaction with the anionic soap surfactant of the invention. Given below are examples of non-cationic antimicrobial agents which are useful in the present invention: pyrithiones (especially zinc pyrithione which is also known as ZPT), dimethyldimethylol hydantoin (Glydant®), methylchloroisothiazolinone/methylisothiazolinone Kathon CG®), sodium sulfite, sodium bisulfite, imidazolidinyl urea (Germall 115®), diazolidinyl urea (Germaill II®), benzyl alcohol, 2-bromo-2-nitropropane-1,3-diol (Bronopol®), formalin (formaldehyde), iodopropenyl butylcarbamate (Polyphase P100®), chloroacetamide, methanamine, methyldibromonitrile glutaronitrile (1,2-Dibromo-2,4-dicyanobutane or Tektamer®), glutaraldehyde, 5-bromo-5-nitro-1,3-dioxane (Bronidox®), phenethyl alcohol, o-phenylphenol/sodium o-phenylphenol, sodium hydroxymethylglycinate (Suttocide A®), polymethoxy bicyclic oxazolidine (Nuosept C®), dimethoxane, thimersal dichlorobenzyl alcohol, captan, chlorphenenesin, dichlorophene, chlorbutanol, glyceryl laurate, halogenated diphenyl ethers like 2,4,4′-trichloro-2′-hydroxy-diphenyl ether (Triclosan® or TCS), 2,2′dihydroxy-5,5′-dibromo-diphenyl ether, phenolic compounds like phenol 2-methyl phenol 3-methyl phenol, 4-methyl phenol, 4-ethyl phenol, 2,4-dimethyl phenol, 2,5-dimethyl phenol, 3,4-dimethyl phenol, 2,6-dimethyl phenol, 4-n-propyl phenol 4-n-butyl phenol 4-n-amyl phenol, 4-tert-amyl phenol, 4-n-hexyl phenol, 4-n-heptyl phenol, mono- and poly-alkyl and aromatic halophenols such as p-chlorophenol, methyl p-chlorophenol ethyl p-chlorophenol, n-propyl p-chlorophenol, n-butyl p-chlorophenol, n-amyl p-chlorophenol, sec-amyl p-chlorophenol n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol 6-diethylmethyl-3-methyl p-chlorophenol, 6-iso-propyl-2-ethyl-3-methyl p-chlorophenol, 2-sec-amyl-3,5-dimethyl p-chlorophenol 2-diethylmethyl-3,5-dimethyl p-chlorophenol, 6-sec-octyl-3-methyl p-chlorophenol, p-chloro-m-cresol, p-bromophenol, methyl p-bromophenol ethyl p-bromophenol, n-propyl p-bromophenol, n-butyl p-bromophenol n-amyl p-bromophenol sec-amyl p-bromophenol, n-hexyl p-bromophenol, cyclohexyl p-bromophenol, o-bromophenol, tert-amyl o-bromophenol n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, dichloro meta xylenol, chlorothymol, 5-chloro-2-hydroxydiphenylmethane, resorcinol and its derivatives including methyl resorcinol, ethyl resorcinol, n-propyl resorcinol, n-butyl resorcinol, n-amyl resorcinol n-hexyl resorcinol, n-heptyl resorcinol, n-octyl resorcinol, n-nonyl resorcinol, phenyl resorcinol benzyl resorcinol, phenylethyl resorcinol, phenylpropyl resorcinol, p-chlorobenzyl resorcinol, 5-chloro 2,4-dihydroxydiphenyl methane, 4′-chloro 2,4-dihydroxydiphenyl methane, 5-bromo 2,4dihydroxydiphenyl methane, and 4′-bromo 2,4-dihydroxydiphenyl methane, bisphenolic compounds like 2,2′-methylene bis(4-chlorophenol), 2,2′-methylene bis(3,4,6-trichlorophenol), 2,2′-methylene bis(4-chloro-6-bromophenol), bis(2-hydroxy-3,5-dichlorophenyl) sulphide, and bis(2-hydroxy-5-chlorobenzyl)sulphide, benzoic esters (parabens) like methylparaben, propylparaben, butylparaben, ethylparaben, isopropylparaben, isobutylparaben, benzylparaben, sodium methylparaben, and sodium propylparaben, halogenated carbanilides (e.g., 3,4,4′-trichlorocarbanilides (Triclocarban® or TCC), 3-trifluoromethyl-4,4′-dichlorocarbanilide, 3,3′,4-trichlorocarbanilide, etc.). The phenol based non-cationic antimicrobials are preferred. The non-cationic antimicrobial agent in the present invention is present in an amount from about 0.05 to about 15 wt %, preferably from about 0.1 to about 5 wt %, and more preferably from about 0.5 to about 5 wt %.

Water soluble organic solvents include short chain (1 to 4 carbon atoms) alcohols, glycol ethers, and mixtures thereof. Such water soluble organic solvents provide effective solubilization of many types of greases and fats which may be encountered in soils, as well as being useful in the solubilization of the pine oil in water, without substantially interfering with the blooming and scent characteristics of the compositions according to the present invention. Of course two or more organic solvents may be used as the organic solvent constituent according to the invention. Examples of short chain alcohols include ethanol propanol, and isopropanol. Examples of such useful glycol ethers include propylene glycol methyl ether, dipropylene glycol methyl ether, tripropylene glycol methyl ether, propylene glycol n-propyl ether, diethylene glycol methyl ether, ethylene glycol butyl ether, diethylene glycol methyl ether, and mixtures thereof. The short chain alcohols are preferred. The water soluble organic solvent constituent may be present in the concentrate compositions in amounts of from about 0.1 to about 20 wt %, preferably in amounts of from about 0.5 to about 10 wt %.

Anionic soap surfactants represent the primary detergent component in the present compositions of interest. This class of surfactants includes ordinary alkali metal soaps such as the sodium, potassium, ammonium and alkanol-ammonium salts of higher fatty acids containing from about 8 to about 24 carbon atoms and preferably from about 10 to about 20 carbon atoms. Suitable fatty acids can be obtained from natural sources such as, for instance, plant or animal esters (e.g., palm oil, coconut oil, babassu oil, soybean oil, castor oil, tallow, whale and fish oils, grease, lard, and mixtures thereof). The fatty acids also can be synthetically prepared (e.g., by the oxidation of petroleum, or by the Fischer-Tropsch process). Resin acids are suitable such as rosin and those resin acids in tall oil. Naphthenic acids are also suitable. Sodium and potassium soaps can be made by direct saponification of the fats and oils or by the neutralization of the free fatty acids which are prepared in a separate manufacturing process. Particularly useful is the sodium or potassium salt of the mixtures of fatty acids derived from castor oil, i.e., sodium or potassium castor oil soap.

The anionic soap surfactant can also comprise traditional anionic surfactants such as alkali metal salts, ammonium salts, amine salts, aminoalcohol salts or the magnesium salts of one or more of the following compounds: alkyl sulfates, alkyl ether sulfates, alkylamidoether sulfates, alkylaryl polyether sulfates, alkylaryl sulfates, alkylaryl sulfonates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms. Of these anionic surfactants, the alkylaryl sulfonates are preferred. From the anionic soap surfactants contemplated herein, the alkyl metal soaps, such as sodium or potassium castor oil soap, are preferred.

The anionic soap surfactant in the present invention comprises an amount from about 0.1 to about 30 wt %, preferably from about 1 to about 20 wt %, and more preferably from about 2 to about 15 wt %.

Another component of the present invention is a hydrocarbon diluent, which is preferably an aromatic hydrocarbon diluent. For example, the hydrocarbon diluent may be Shellsolv AB, Aromatic 150, Chemical Abstract Service (CAS) Registry No. 64742-94-5; Aromatic 200 (naphthalene depleted), CAS Registry No. 64742-94-5; Aromatic 200, Aromatic 100, CAS Registry No. 64742-95-6; and HAN (heavy atmospheric naphtha) 857, CAS Registry No. 64742-06-9. Aromatic 200 is generally preferred. Shellsolv AB is commercially available from Shell Chemical Company. Aromatic 150, Aromatic 100, Aromatic 200 (naphthalene depleted), Aromatic 200, and HAN 857 are commercially available from ExxonMobil. Other suitable aromatic solvents are available from Koch Chemical, Ashland, Amoco, and Texaco as well as the Isopar, Exxsol and Norpar aliphatic, isoparaffins and paraffins from ExxonMobil. The hydrocarbon diluent is preferably present in the present composition in an amount of about 0.1 to about 15 wt %, preferably in an amount of from about 0.1 to about 10 wt % and more preferably in an amount of from about 0.5 to about 5 wt %.

The compositions according to the present invention also comprise a pine oil constituent. Pine oil is an organic solvent, and is a complex blend of oils, alcohols, acids, esters, aldehydes and other organic compounds. These include terpenes which include a large number of related alcohols or ketones. Some important constituents include terpineol, which is one of three isomeric alcohols having the basic molecular formula C₁₀H₁₇OH. One type of pine oil, synthetic pine oil, will generally have a specific gravity, at 15.5° C. of about 0.9300, which is lower than the two other grades of pine oil, namely steam distilled and sulfate pine oils, and will generally contain a higher content of turpentine alcohols. Other important compounds include alpha- and beta-pinene (turpentine), abietic acid (rosin), and other isoprene derivatives.

Particularly useful pine oils which are presently commercially available include Unipine® 60 (from Union Camp, believed to contain approximately 60% terpene alcohols), Unipine® S-70 and Unipine® S-70 (both are believed to contain approximately 70% terpene alcohols), Unipine® S and Unipine® 80 (both are believed to contain approximately 80% terpene alcohols), Unipine® 85 (which is believed to contain approximately 85% terpene alcohols), Unipine® 90 (which is believed to contain approximately 90% terpene alcohols), as well as Alpha Terpineol 90 (which is believed to contain approximately 100% terpene alcohols). Further useful pine oils include Glidco®D Pine Oil™ 60 (available from Glidco Organics Corp., Jacksonville, Fla., believed to contain approximately 60% terpene alcohols), Glidco® Pine Oil 140 (believed to contain approximately 70% terpene alcohols), Glidco® Pine Oil 80 (believed to contain approximately 80% terpene alcohols), Glidco® Pine Oil 150 (believed to contain approximately 85% terpene alcohols); Glidco® Terpene SW (believed to contain approximately 75% terpene alcohols); as well as Glidco® Terpineol 350 (believed to contain approximately 100% terpene alcohols). Other products which can contain up to 100% pure alpha-terpineol, may also be used in the present invention.

Preferred as the pine oil constituent of the present invention are pine oil preparations which comprise at least about 60% terpene alcohols, and more preferably those which comprise at least about 80% terpene alcohols.

The pine oil constituent may be present in the concentrate compositions in amounts of from about 0.001 to about 20 wt %, preferably in amounts of from about 0.1 to about 15 wt % and more preferably from about 0.5 to about 10 wt %.

As the concentrate compositions are aqueous, water forms a major constituent. Water is added in order to provide 100 wt % of the concentrate composition. The water may be tap water, but is preferably distilled and/or deionized water. If the water is tap water, it is preferably appropriately filtered in order to remove any undesirable impurities such as organics or inorganics, especially mineral salts which are present in hard water which may thus interfere with the operation of the other constituents of the invention, as well as any other optional components of the liquid concentrates according to the invention.

Water is added in amounts which are sufficient to form the concentrated compositions which amount is sufficient to ensure the retention of a substantially clear characteristic when produced as a concentrate, but at the same time ensuring good blooming upon the addition of the concentrated composition to a further amount of water, or upon the addition of further water to the concentrate. This amount may be readily determined by first mixing measured amount of the non-water constituents in a suitably sized vessel and then during stirring adding water. Generally, water is present in the concentrate compositions in amounts in excess of about 50 wt %, preferably in amounts of in excess of about 70 wt %, but most preferably in amount of between 70-80 wt % based on the total weight of the concentrate compositions according to the invention.

As noted previously, the concentrate compositions according to the invention may include further optional, but advantageously included constituents.

Useful optional constituents are one or more coloring agents which find use in modifying the appearance of the concentrate compositions and enhance their appearance from the perspective of a consumer or other end user. Known coloring agents, may be incorporated in the compositions in effective amount to improve or impart to concentrate compositions an appearance characteristic of a pine oil type concentrate composition, such as a color ranging from colorless to yellow or yellow/brown color with or without fluorescent ingredients. Such a coloring agent or coloring agents may be added in any useful amount in a conventional fashion, i.e., admixing to a concentrate composition or blending with other constituents used to form a concentrate composition. However, other colors atypical of pine oil type and/or lemon oil type cleaning concentrates may be used as well. Known art light stabilizer constituents useful in pine oil type compositions may also be added, particularly wherein coloring agents are used in a composition. As is known to the art, such light stabilizers act to retain the appearance characteristics of the concentrate compositions over longer intervals of time.

Further useful optional constituents which may in some cases be desirably included in the inventive compositions include rheology modifying agents such as thickeners.

Other conventional additives known to the art but not expressly enumerated here may also be included in the compositions according to the invention. By way of non-limiting example these may include fragrance/fragrance adjusters (which do not interfere with the pine oil constituent of the present invention (can generally be present in an amount of from about 0.000001 to about 1.5 wt % of the total concentrate, preferably non-pine oil based)), pH adjusters, pH buffering agents, non-ionic surfactants and insect repellants. Such non-ionic surfactants denoted here are conventionally known; examples are described in McCutcheon's Detergents and Emulsifiers, North American Edition, 2001; Kirk-Othmer, Encyclopedia of Chemical Technology, 4th Ed., Vol. 23, pp. 478-541, the contents of which are herein incorporated by reference. Such optional constituents should be selected so to have little or no detrimental effect upon the desirable characteristics of the present invention, namely the blooming behavior, cleaning efficacy, and disinfectant activity, low toxicity as provided by the inventive compositions. Generally the total weight of such further conventional additives may comprise up to 10 wt % of a concentrated composition formulation.

In certain preferred instances, one of the optional constituents, insect repellants, may be a required component of an inventive composition.

Examples of insect repellants which can be used include those such as essential oils (such as, for example, oils of anise, citrus, aniseed, roses, mint, camphor, lemon, orange, rosemary, wintergreen, thyme, lavender, cloves, hops, tea tree, citronella, wheat, barley, lemongrass, cedar leaf, cedarwood, palmarosa, vetiver, sage, lime, juniper berry, cinnamon, fleagrass, geranium, sandalwood, violet, ginger, bergamot, marjoram, pepper, jasmine, chamomile, petitgrain, cranberry, eucalyptus, vervain, peppermint, gum benzoin, basil, fennel, fir, balsam, menthol, ocmea origanum, hydastis carradensis, berberidaceae daceae, ratanhiae, curcuma longa, Mentha arvensis (Cornmint), Mentha spicata (American Spearmint), Mentha cardica (Scotch Spearmint), (−)-Limonene, (+)-Limonene, (−)-Carvone, Linalool, Alpha and Beta-Terpineol, Fencholic acid, Bomeol iso Bomeol, Bornyl acetate and iso Bomyl acetate. Also included in this class of natural essential oils are the key chemical components of the plant oils which have been found to provide the antimicrobial benefit. These chemicals include, but are not limited to anethol, catechole, camphene, pinocarvone, cedrol, thymol, eugenol, eucalyptol, ferulic acid, farnesol, hinokitiol, tropolone, limonene, menthol, methyl salicylate, carvacol, teipineol, verbenone, berberine, ratanhiae extract, caryophellene oxide, citronellic acid, curcumin, nerolidol and geraniol), N,N-diethyl-m-toluamide, diethyl phthalate, dimethyl phthalate, dibutyl phthalate, 2-Hydroxyethyl-n-octyl sulfide, N-Octyl bicycloheptene dicarboximide, Hexahydrodibenzofuran carboxaldehyde, Di-n-propyl isocinchomerate, 2-Ethyl-1,3-hexanediol, 2-(n-butyl)-2-ethyl-1,3-propanediol, Dibutyl succinate, Piperonyl butoxide, Pyrethrum, certain fragrances, those agents listed in, for example, U.S. Pat. No. 6,451,844, n-alkylneoalkanamides (such as those described in U.S. Pat. Nos. 5,006,562; 5,015,665; 5,143,900; 5,182,304; 5,182,305; 5,258,408; 5,391,578; and 5,434,189; the disclosures of which are incorporated herein by reference) where, for example, n-alkylneoalkanamide can have a formula of 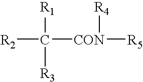
wherein R₁, R₂, and R₃ are alkyl groups and the sum of the carbon atoms therein is from 6 to 12, and wherein R₄ is either a hydrogen atom or an alkyl group having one or two carbon atoms and wherein R₅ is an alkyl group having one to three carbon atoms.

When present, the insect repellant is present in the formulations of the present invention in an amount of from about 0.1 to about 5 wt %.

What is to be understood by the term “concentrate” and “concentrate composition” in this specification and claims is the pre-consumer dilution and composition of the cleaning composition which is the essentially the form of the product prepared for sale to the consumer or other end user with required product shelf life. Such a consumer or other end user would then normally be expected to dilute the same with water to form a cleaning composition. It is to be understood however that nothing in this invention would bar its use as cleaning composition without any further dilution and it may be used in the concentrations in which it was prepared for sale. Similarly, what is to be understood by the term “cleaning compositions” are the water diluted compositions which are expected to be prepared by the consumer or other end user by mixing a measured amount of the “concentrate” with water in order to form an appropriately diluted cleaning composition which is suitable for use in cleaning applications, especially in the cleaning of hard surfaces.

It is also to be understood, that proportions of one or more constituents have been and generally are referred to as percent by weight or as parts by weight based on a measure of 100% by weight, unless otherwise indicated.

As generally denoted above, the formulations according to the invention include both cleaning compositions and concentrates as outlined above which differ only in the relative proportion of water to that of the other constituents forming such formulations. While the concentrated form of the cleaning compositions find use in their original form, they are more frequently used in the formation of a cleaning composition therefrom. Such may be easily prepared by diluting measured amounts of the concentrate compositions in water by the consumer or other end user in certain weight ratios of concentrate:water, and optionally, agitating the same to ensure even distribution of the concentrate in the water. As noted, the concentrate may be used without dilution, i.e., in concentrate:water concentrations of 1:0, to extremely dilute dilutions such as 1:2000. Desirably, the concentrate is diluted in the range of 1:0.1-1:1000, preferably in the range of 1:10-1:500 but most preferably in the range of 1:50-1:200. The actual dilution selected is in part determinable by the degree and amount of dirt and grime to be removed from a surface(s), the amount of mechanical force imparted to remove the same, as well as the observed efficacy of a particular dilution. Generally better results and faster removal is to be expected at lower relative dilutions of the concentrate in water.

### EXAMPLES

Preparation of Example Formulations:

Exemplary formulations illustrating certain preferred embodiments of the inventive compositions and described in more detail in Table I below were formulated generally in accordance with the following protocol.

Into a suitably sized vessel, a measured amount of the non-cationic antimicrobial agent (e.g., PCMX, DCMX was provided after which the remaining organic based components (e.g., hydrocarbon diluent, pine oil, water soluble organic solvent, dye (if any). These components were stirred until the non-cationic antimicrobial agent was fully dissolved. The anionic soap surfactant is then added to the organic solution and the components are stirred until the mixture is homogeneous. The remaining amount of water is then added to the organic/anionic soap surfactant mixture and the components are then mixed until the solution is clear and homogeneous. Mixing of the various components at the various times can range from 5 minutes to 120 minutes, depending on the volume of the mixture; the amount of time can vary so long as particular solutions appeared to be homogeneous. The exemplary compositions were readily pourable, and retained well mixed characteristics (i.e., stable mixtures) upon standing for extended periods, even in excess of 90 days. The exemplary compositions are also stable at elevated temperatures up to 120° F. for several weeks.

Examples of inventive formulations are shown in Table 1 below.

TABLE 1

| Components | Ex. 1 | Ex. 2 | Ex. 3 | Ex. 4 | Ex. 5 | Ex. 6 | Ex. 7 |
|---|---|---|---|---|---|---|---|
| Aromatic 200 | 4.00 | 1.50 | 1.50 | 0.00 | 1.50 | 1.00 | 0.30 |
| Pine Oil 80 | | 1.00 | 1.00 | 2.00 | 1.00 | 2.00 | 3.50 |
| PCMX¹ | 10.00 | 1.50 | 1.50 | 1.50 | 0.00 | 1.40 | |
| DCMX² | | | | | 1.50 | | |
| OBPCP | | | | | | | 1.50 |
| IPA³ | 4.00 | 2.00 | 2.00 | 3.00 | 2.00 | | 3.00 |
| Na COS⁴ | 12.93 | 20.00 | 20.00 | 35.00 | 20.00 | 35.00 | 20.00 |
| SDS⁵ | 0.80 | | | | | | |
| SLS⁶ | | | | | | 3.00 | |
| NP-9 | | | | | | 0.60 | |
| Insect repellant⁷ | | | 0.40 | 4.00 | 0.40 | 5.00 | |
| Dye (1%) | | 0.25 | | | | | |
| Water, DI | 68.27 | 73.75 | 73.60 | 54.50 | 73.60 | 52.00 | 71.70 |
| Total | 100.01 | 100.00 | 100.00 | 100.00 | 100.00 | 100.00 | 100.00 |

| Components | Ex. 8 | Ex. 9 | Ex. 10 | Ex. 11 | Ex. 12 | Ex. 13 |
|---|---|---|---|---|---|---|
| Aromatic 200 | 1.50 | 0.30 | 0.50 | 1.50 | 1.50 | 0.00 |
| Aromatic 200 (naphthalene | | | | | | 0.40 |
| depleted) | | | | | | |
| Pine Oil 80 or 85 | 1.00 | 3.00 | 2.00 | 0.80 | 1.60 | 2.00 |
| PCMX | 1.40 | 0.00 | 0.00 | 1.50 | 1.50 | 1.50 |
| OBPCP⁸ | | 1.50 | 1.50 | | | |
| IPA | 2.00 | 3.00 | 3.00 | 2.00 | 2.00 | 3.00 |
| Na COS | 18.00 | 18.00 | 20.00 | 20.00 | 20.00 | 35.00 |
| NP-9⁹ | | | 1.00 | | | |
| Insect repellant | | | | 0.40 | 0.40 | 0.40 |
| Fragrance Oils¹⁰ | 0.25 | | | 0.20 | 0.40 | |
| Water, DI | 76.10 | 74.20 | 72.00 | 73.60 | 72.60 | 54.10 |
| Total | 100.00 | 100.00 | 100.00 | 100.00 | 100.00 | 100.00 |

¹p-chloro-m-xylene
²dichloro meta xylenol
³isopropanol
⁴sodium castor oil soap (40%)
⁵sodium dodecyl benzene sulfonate (40%)
⁶sodium lauryl suflate (30%)
⁷dimethyl phthalate
⁸ortho-benzyl-para-chlorophenol
⁹nonylphenol ethoxylates (9 moles EO)
¹⁰lemongrass oil or eucalyptus oil

The compositions of the present invention were evaluated for bloom, cleaning and disinfecting properties.

The formulations according to Ex. 1 through Ex. 13 are clear (although some examples contain dye but these dyes do not affect the clarity of the compositions), but when diluted at ratios of 1 part to 100 parts or 200 parts of water at both 20° C. and 35° C., in the as mixed aqueous dilutions are expected to achieve the targeted loss of light transmittance of about 40% and more. Ex. 2, with and without insect repellant, was tested for bloom. In certain regions of the world where cold water is used for cleaning purposes, formulations of the present invention can achieve a loss of light transmission greater than 90%.

Light transmittance values closer to zero indicate improved blooming behavior. The protocol for evaluating light transmittance is described as follows: The results of the light transmittance evaluation was determined as a percentage of light transmitted through a sample of a particular aqueous dilution wherein the transmission of a like sample of water is assigned a percentage of 100%. Testing was performed by preparing a 1:100 or 1:200 dilution of the example formulation:water, (tap water) after which the sample was mixed for 30 seconds and a transmittance reading was taken using a Brinkman model PC801 dipping probe colorimeter, which was set at 620 nm to determine the light transmission of each of the samples. Readings were taken at water temperatures of 20° C. and at 35° C. were evaluated, as well as the reference (pure tap water) sample used to calibrate the calorimeter to the reference 100% light transmission sample outlined above. The results are shown in Table 2 below.

TABLE 2

| | | |
|---|---|---|
| Composition | 1:100 | 1:200 |

In water at 20° C.

| | | |
|---|---|---|
| Ex. 2 w/IR¹ | 0.5 | 1.3 |
| Ex. 2 w/o IR | 0.4 | 1.1 |

In water at 35° C.

| | | |
|---|---|---|
| Ex. 2 w/IR | 34.6 | 50.6 |
| Ex. 2 w/o IR | 31.3 | 61.7 |

¹IR is an insect repellant

These results provide an empirical evaluation of the degree of transparency of a diluted example formulation wherein 0% indicates complete opacity and 100% the transparency of the sample. Accordingly, a lower reported light transmittance value of a particular aqueous dilution provided a more desirable indication of the blooming characteristic of the particular aqueous dilution. It can be noted that in some instances, warm water will be “soft” and cold water will be “hard.” In the above table, the warm (35° C.) water was treated (or “soft”) and thus the blooming characteristics are somewhat reduced. However, if non-softened warm water were used, similar blooming characteristics to those seen in cold water would be achieved.

Cleaning Evaluations

Cleaning evaluations were performed in accordance with the testing protocol outlined according to ASTM D4488 AZ Test Method, which evaluated the efficacy of the cleaning compositions on masonite wallboard samples painted with wall paint. The soil applied was a greasy soil sample containing vegetable oil, food shortening and animal fat. The sponge (water dampened) of a Gardner Abrasion Tester apparatus was squirted with a 15 gram sample of a tested cleaning composition, and the apparatus was cycled 10 times. The evaluation of cleaning compositions was “paired” with one side of each of the test samples treated with a composition according to the invention, and the other side of the same sample treated with a comparative example's composition, thus allowing a “side-by-side” comparison to be made. Each of these tests were duplicated on 5 wallboard tiles and the results statistically analyzed and the averaged results reported on Table 3, below. The cleaning efficacy of the tested compositions was evaluated utilizing a Minolta Chroma Meter CF-110, with Data Processor DP-100, which evaluated spectrophotomic characteristics of the sample. The results are reported on Table 3, following.

TABLE 3

| Composition | Average % Soil Removal |
|---|---|
| Ex. 2 | 90.05 |
| Dettol Multi-Purpose Disinfectant | 91.45 |
| from Reckitt Benckiser | |
| Domex Disinfectant Cleaner from | 57.64 |
| Lever Johnson | |
| Domex 2-in-1 Phenolic Cleaner | 69.55 |
| from Lever Johnson | |
| Lizol Pineol Shakti Disinfectant | 87.25 |
| Cleaner from Reckitt Benckiser | |

With respect to the results reported on Table 3 a value of “100” is indicative of total soil removal and a “0” value is indicative no soil removal. As can be seen from the results of Table 3, the cleaning efficacy of the composition according to the invention generally provided superior results or were on parity with those of known art cleaning products.

Evaluation of Antimicrobial Efficacy

Representative compositions of the present invention were evaluated in order to evaluate their antimicrobial efficacy against Staphylococcus aureus (gram positive type pathogenic bacteria) (ATCC 6538), and Salmonella choleraesuis (gram negative type pathogenic bacteria) (ATCC 10708). The testing was performed generally in accordance with the protocols outlined in “Use-Dilution Method” as promulgated by the Association of Official Analytical Chemists (AOAC).

The results of the AOAC Use-Dilution Test Method indicates the number of test substrates wherein the tested organism remains viable after contact for 10 minutes with a test disinfecting composition/total number of tested substrates (plates) evaluated in accordance with the AOAC Use-Dilution Test. Thus, a result of “0/10” indicates that of 10 test substrates bearing the test organism and contacted for 10 minutes in a test disinfecting composition, 0 test substrates had viable (live) test organisms at the conclusion of the test. Such a result is excellent, illustrating the excellent disinfecting efficacy of the tested composition.

Results of the antimicrobial testing are indicated on Table 4, below. The reported results indicate the number of test plates with live test organisms/number of test plates tested for each example formulation and organism tested.

TABLE 4

| Composition (dilution) | S. aureus | S. choleraesuis |
|---|---|---|
| Ex. 3 (1:50) | 0/10 | Not tested |
| Ex. 7 (1:20) | 0/10 | 0/10 |

Composition Ex. 3 with added dye was evaluated at three dilutions (1:60; 1:90; and 1:100 compositions:water) using the Biomek® 2000 Laboratory Automation Workstation together with the BioWorks Operating System (available from Beckman Coulter Inc., Fullerton, Calif.) with the above organisms at a concentration of 9 logs. The Biomek simulates a microbial reduction suspension test. One part of organism suspension (Staphylococcus aureus or Salmonella choleraesuis) is added to certain dilutions of Ex. 3 in an appropriate container. Deionized water (DI H₂O) was used a control. The organism and sample are then mixed thoroughly for 15 seconds. Serial tenfold dilutions are carried out in a neutralizing broth. The diluted samples are then incubated for 2448 hours at 35-37° C. Thereafter, surviving organisms are quantified and Log10 reduction, as a measurement of organism survivors are calculated as follows:
Log10 Reduction=(Log10 Survivors/DI H₂O Control)−(Log10 Survivors/Sample)

For this test with a contact time of 15 second, a Log10 reduction value of 3 or greater against both organisms is a good indication of acceptable performance (i.e., broad spectrum antimicrobial activity). The results of this evaluation are summarized in Table 5 below.

TABLE 5

| Organism/dilution | 1:60 | 1:90 | 1:100 |
|---|---|---|---|
| S. aureus | >6 log | 6.7 | 3.99 |
| S. choleraesuis | >6 log | 4.03 | 2.7 |

Various compositions were tested for insect repellency (against American cockroach (Periplaneta americana) on either vinyl flooring or mosaic flooring. In either using vinyl flooring or mosaic flooring, a 100 cm×100 cm square was treated with the compositions at two concentrations: neat and at 5 ml composition/1000 ml water. The compositions were applied to the surface and allowed to dry for 30 minutes.

The treated surface (either vinyl or mosaic) was placed in one half of a suitably sized tray with a similar sized untreated surface placed in the other half of the tray. At the center of each surface (treated and untreated) were placed two 30 cm×30 cm sheets of Formica® to act as a cockroach harborage. The Formica® sheet in the treated section was treated at the same rate as the treated surface.

Fifty cockroaches (15 adults, 35 nymphs) were placed in the middle of the tray. No food or water was supplied to the cockroaches.

At the end of thirty minutes, 3 hours, 6 hours, and 12 hours, the number of cockroaches under each Formica® harborage was counted.

Each assay was repeated three times with three replicates each time. The data are shown below in Tables 6, 6A, 7, and 7A.

TABLE 6
Formulations tested Neat on Vinyl Flooring

| | The number of cockroaches present in each harborage of treated | | | | | | | | |
|---|---|---|---|---|---|---|---|---|---|
| | and untreated vinyl flooring surfaces in different time intervals | | | | | | | | |
| | (each value is the mean of three individual observations) | | | | | | | | |
| | | Time in hours | | | | | | | |
| | Trial | 30 minutes | | 3 hours | | 6 hours | | 12 hours | |
| Ex. | No. | T | Un. T | T | Un. T | T | Un. T | T. | Un. T |
| Ex. 5 | I | 4 | 14 | 8 | 20 | 14 | 20 | 26 | 24 |
| | II | 6 | 16 | 15 | 22 | 16 | 25 | 16 | 32 |
| | III | 3 | 20 | 12 | 23 | 16 | 24 | 18 | 29 |
| Ex. 4 | I | 3 | 19 | 7 | 23 | 15 | 26 | 26 | 24 |
| | II | 1 | 16 | 10 | 24 | 18 | 22 | 24 | 26 |
| | III | 1 | 18 | 13 | 21 | 19 | 24 | 20 | 29 |
| Ex. 3 | I | 8 | 19 | 12 | 22 | 18 | 23 | 27 | 18 |
| | II | 4 | 17 | 17 | 21 | 16 | 27 | 20 | 26 |
| | III | 6 | 16 | 14 | 22 | 17 | 21 | 22 | 24 |

TABLE 6A
Formulations tested 5 ml Ex./1000 ml water on Vinyl Flooring

| | The number of cockroaches present in each harborage of treated | | | | | | | | |
|---|---|---|---|---|---|---|---|---|---|
| | and untreated vinyl flooring surfaces in different time intervals | | | | | | | | |
| | (each value is the mean of three individual observations) | | | | | | | | |
| | | Time in hours | | | | | | | |
| | Trial | 30 minutes | | 3 hours | | 6 hours | | 12 hours | |
| Ex. | No. | T | Un. T | T | Un. T | T | Un. T | T | Un. T |
| Ex. 5 | I | 8 | 12 | 22 | 15 | 25 | 22 | 31 | 18 |
| | II | 10 | 15 | 22 | 18 | 22 | 24 | 23 | 24 |
| | III | 9 | 16 | 18 | 21 | 25 | 23 | 20 | 26 |
| Ex. 4 | I | 11 | 15 | 17 | 22 | 23 | 20 | 31 | 19 |
| | II | 10 | 13 | 19 | 26 | 20 | 28 | 20 | 28 |
| | III | 10 | 20 | 12 | 26 | 18 | 26 | 20 | 28 |
| Ex. 3 | I | 13 | 15 | 19 | 22 | 20 | 22 | 24 | 24 |
| | II | 15 | 16 | 26 | 22 | 25 | 23 | 20 | 27 |
| | III | 12 | 18 | 23 | 18 | 27 | 19 | 20 | 20 |

TABLE 7
Formulations tested Neat on Mosaic Flooring

| | The number of cockroaches present in each harborage of treated | | | | | | | | |
|---|---|---|---|---|---|---|---|---|---|
| | and untreated mosaic flooring surfaces in different time intervals | | | | | | | | |
| | (each value is the mean of three individual observations) | | | | | | | | |
| | | Time in hours | | | | | | | |
| | Trial | 30 minutes | | 3 hours | | 6 hours | | 12 hours | |
| Ex. | No. | T | Un. T | T | Un. T | T | Un. T | T | Un. T |
| Ex. 5 | I | 2 | 18 | 8 | 24 | 14 | 26 | 23 | 27 |
| | II | 1 | 14 | 9 | 26 | 17 | 28 | 24 | 26 |
| | III | 0 | 16 | 11 | 28 | 20 | 24 | 21 | 29 |
| Ex. 4 | I | 6 | 12 | 10 | 19 | 15 | 21 | 25 | 25 |
| | II | 5 | 18 | 16 | 23 | 18 | 24 | 22 | 28 |
| | III | 2 | 21 | 11 | 24 | 17 | 23 | 24 | 25 |
| Ex. 3 | I | 7 | 18 | 14 | 23 | 16 | 23 | 21 | 29 |
| | II | 6 | 14 | 17 | 27 | 17 | 27 | 19 | 26 |
| | III | 4 | 16 | 13 | 21 | 18 | 21 | 24 | 23 |

TABLE 7A
Formulations tested 5 ml Ex./1000 ml water on Mosaic Flooring

| | The number of cockroaches present in each harborage of treated | | | | | | | | |
|---|---|---|---|---|---|---|---|---|---|
| | and untreated mosaic flooring surfaces in different time intervals | | | | | | | | |
| | (each value is the mean of three individual observations) | | | | | | | | |
| | | Time in hours | | | | | | | |
| | Trial | 30 minutes | | 3 hours | | 6 hours | | 12 hours | |
| Ex. | No. | T | Un. T | T | Un. T | T | Un. T | T | Un. T |
| Ex. 5 | I | 12 | 15 | 18 | 22 | 19 | 22 | 22 | 24 |
| | II | 10 | 16 | 19 | 26 | 22 | 26 | 24 | 26 |
| | III | 9 | 21 | 21 | 26 | 23 | 26 | 20 | 26 |
| Ex. 4 | I | 9 | 14 | 20 | 19 | 20 | 22 | 20 | 24 |
| | II | 10 | 19 | 22 | 24 | 25 | 24 | 25 | 24 |
| | III | 12 | 21 | 21 | 21 | 21 | 25 | 22 | 25 |
| Ex. 3 | I | 11 | 18 | 24 | 19 | 24 | 21 | 24 | 23 |
| | II | 16 | 16 | 27 | 22 | 25 | 23 | 22 | 24 |
| | III | 14 | 20 | 23 | 22 | 23 | 22 | 20 | 23 |

1. A hard surface cleaning concentrate composition comprising:
a) from about 0.05 to about 10 wt % of a non-cationic antimicrobial agent;
b) from about 1 to about 20 wt % of a water soluble organic solvent;
c) from about 1 to about 20 wt % of an anionic soap surfactant;
d) from about 1 to about 15 wt % of an hydrocarbon diluent;
e) from about 0.001 to about 20 wt % of pine oil which is at least 60% terpene alcohols;
f) optionally, from about 0 to about 10 wt % of optional materials selected from dyes, colorants, pH stabilizers and buffers, non-ionic surfactants, fragrance/fragrance enhancers, viscosity modifiers, insect repellants, and light stabilizers; and
g) the balance being water.

2. The cleaning concentrate of claim 1 wherein the non-cationic antimicrobial agent is selected from pyrithiones, dimethyldimethylol hydantoin, methylchloroisothiazolinone/methylisothiazolinone sodium sulfite, sodium bisulfite, imidazolidinyl urea, diazolidinyl urea, benzyl alcohol, 2-bromo-2-nitropropane-1,3-diol, formal in (formaldehyde), iodopropenyl butylcarbamate, chloroacetamide, methanamine, methyldibromonitrile glutaronitrile, glutaraldehyde, 5-bromo-5-nitro-1,3-dioxane, phenethyl alcohol, o-phenylphenol/sodium o-phenylphenol, sodium hydroxymethylglycinate, polymethoxy bicyclic oxazolidine, dimethoxane, thimersal dichlorobenzyl alcohol, captan, chlorphenenesin, dichlorophene, chlorbutanol, glyceryl laurate, halogenated diphenyl ethers, phenolic compounds, mono- and poly-alkyl and aromatic halophenols, resorcinol and its derivatives, bisphenolic compounds, benzoic esters (parabens), halogenated carbanilides, 3-trifluoromethyl-4,4′-dichlorocarbanilide, and 3,3′,4-trichlorocarbanilide.

3. The cleaning concentrate of claim 2 wherein the non-cationic antimicrobial agent is a mono- and poly-alkyl and aromatic halophenol selected from the group p-chlorophenol, methyl p-chlorophenol, ethyl p-chlorophenol, n-propyl p-chlorophenol, n-butyl p-chlorophenol, n-amyl p-chlorophenol, sec-amyl p-chlorophenol, n-hexyl p-chlorophenol, cyclohexyl p-chlorophenol, n-heptyl p-chlorophenol, n-octyl p-chlorophenol, o-chlorophenol, methyl o-chlorophenol, ethyl o-chlorophenol, n-propyl o-chlorophenol, n-butyl o-chlorophenol, n-amyl o-chlorophenol, tert-amyl o-chlorophenol, n-hexyl o-chlorophenol, n-heptyl o-chlorophenol, o-benzyl p-chlorophenol, o-benzyl-m-methyl p-chlorophenol, o-benzyl-m, m-dimethyl p-chlorophenol, o-phenylethyl p-chlorophenol, o-phenylethyl-m-methyl p-chlorophenol, 3-methyl p-chlorophenol, 3,5-dimethyl p-chlorophenol, 6-ethyl-3-methyl p-chlorophenol, 6-n-propyl-3-methyl p-chlorophenol, 6-iso-propyl-3-methyl p-chlorophenol, 2-ethyl-3,5-dimethyl p-chlorophenol, 6-sec-butyl-3-methyl p-chlorophenol, 2-iso-propyl-3,5-dimethyl p-chlorophenol, 6-diethylmethyl-3-methyl p-chlorophenol, 6-iso-propyl-2-ethyl-3-methyl p-chlorophenol, 2-sec-amyl-3,5-dimethyl p-chlorophenol 2-diethylmethyl-3,5-dimethyl p-chlorophenol, 6-sec-octyl-3-methyl p-chlorophenol, p-chloro-m-cresol, p-bromophenol, methyl p-bromophenol, ethyl p-bromophenol, n-propyl p-bromophenol, n-butyl p-bromophenol, n-amyl p-bromophenol, sec-amyl p-bromophenol, n-hexyl p-bromophenol, cyclohexyl p-bromophenol, o-bromophenol, tert-amyl o-bromophenol, n-hexyl o-bromophenol, n-propyl-m,m-dimethyl o-bromophenol, 2-phenyl phenol, 4-chloro-2-methyl phenol, 4-chloro-3-methyl phenol, 4-chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol, dichloro meta xylenol, chlorothymol, and 5-chloro-2-hydroxydiphenylmethane,

4. The composition of claim 1 wherein the water soluble organic solvent is selected from C1-4 alcohols, glycol ethers, and mixtures thereof.

5. The composition of claim 1 wherein the anionic soap surfactant is selected from alkali metal soap fatty acids containing from about 8 to about 24 carbon atoms, alkali metal salts, ammonium salts, amine salts, aminoalcohol salts or the magnesium salts of one or more of the following compounds: alkyl sulfates, alkyl ether sulfates, alkylamidoether sulfates, alkylaryl polyether sulfates, alkylaryl sulfates, alkylaryl sulfonates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates.

6. The composition of claim 5 wherein the anionic soap surfactant is selected from alkali metal soap fatty acids.

7. The composition of claim 1 wherein the hydrocarbon diluent is an aromatic hydrocarbon diluent selected from Shellsolv AB, Aromatic 150, Aromatic 200 (naphthalene depleted), Aromatic 200, Aromatic 100, and HAN 857.

8. The composition of claim 1 wherein the non-cationic antimicrobial agent is present in an amount of from about 0.1 to about 5 wt %.

9. The composition of claim 1 wherein the water soluble organic solvent is present in an amount of from about 0.5 to about 10 wt %.

10. The composition of claim 1 wherein the anionic soap surfactant is present in an amount of from about 1 to about 20 wt %.

11. The composition of claim 1 wherein the hydrocarbon diluent is present in an amount of from about 0.1 to about 10 wt %.

12. The composition of claim 1 wherein the pine oil is present in an amount of from about 0.1 to about 15 wt %.

13. (canceled)

14. (canceled)

15. The cleaning concentrate according to claim 1 which contain one or more insect repellants.

16. The cleaning concentrate of claim 15 wherein the amount of one or more insect repellant ranges from about 0.1 to about 5 wt %.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A hard surface cleaning concentrate composition according to claim 1 comprising:
a) from about 0.1 to about 5 wt % of a non-cationic antimicrobial agent;
b) from about 0.5 to about 10 wt % of a water soluble organic solvent;
c) from about 1 to about 20 wt % of an anionic soap surfactant;
d) from about 0.1 to about 10 wt % of an hydrocarbon diluent;
e) from about 0.1 to about 15 wt % of pine oil which is at least 60% terpene alcohols;
f) from about 0.1 to about 5 wt % of one or more insect repellants; and
g) the balance being water.

30. (canceled)

31. The cleaning concentrate according to claim 15 one or more insect repellents is selected from essential oils selected from oils of anise, citrus, aniseed, roses, mint, camphor, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, basil, fennel, fir, balsam, menthol, ocmea origanum, hydastis carradensis, berberidaceae daceae, ratanhiae, curcuma longa, Mentha arvensis (Cornmint), Mentha spicata (American Spearmint), Mentha cardica (Scotch Spearmint), (−)-Limonene, (+)-Limonene, (−)-Carvone, Linalool, Alpha and Beta-Terpineol, Fencholic acid, Bomeol iso Borneol, Bornyl acetate and iso Bornyl acetate and related chemical components of the plant oils selected from anethol, catechole, camphene, pinocarvone, cedrol, thymol, eugenol, eucalyptol, ferulic acid, farnesol, hinokitiol, tropolone, limonene, menthol, methyl salicylate, carvacol, terpineol, verbenone, berberine, ratanhiae extract, caryophellene oxide, citronellic acid, curcumin, nerolidol and geraniol; N,N-diethyl-m-toluamide, diethyl phthalate, dimethyl phthalate, dibutyl phthalate, 2-Hydroxyethyl-n-octyl sulfide, N-Octyl bicycloheptene dicarboximide, Hexahydrodibenzofuran carboxaldehyde, Di-n-propyl isocinchomerate, 2-Ethyl-1,3-hexanediol, 2-(n-butyl)-2-ethyl-1,3-propanediol, Dibutyl succinate, Piperonyl butoxide, Pyrethrum, fragrances, n-alkylneoalkanamides having a formula of 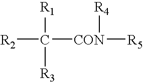
wherein R₁, R₂, and R₃ are alkyl groups and the sum of the carbon atoms therein is from 6 to 12, and wherein R₄ is either a hydrogen atom or an alkyl group having one or two carbon atoms and wherein R₅ is an alkyl group having one to three carbon atoms.
